(19) United States
(12) Patent Application Publication
(10) Pub. No.: US 2018/0128646 A1
(43) Pub. Date: May 10, 2018

(54) VERY NARROWBAND MESH SYSTEM USING SINGLE-MODE TRANSPONDERS

(71) Applicant: Thomas Meek, Atlanta, GA (US)

(72) Inventor: Thomas Meek, Atlanta, GA (US)

(21) Appl. No.: 15/804,893

(22) Filed: Nov. 6, 2017

Related U.S. Application Data
(60) Provisional application No. 62/418,050, filed on Nov. 4, 2016.

(51) Int. Cl. G01D 4/00; H04J 3/02; H04Q 9/00

(52) U.S. Cl. CPC G01D 4/002; H04J 3/02; H04Q 2209/40; H04Q 2209/25; H04Q 9/00

(57) ABSTRACT

A very narrowband mesh communication system utilizes single-mode transponders for “hop” communications between meters and data collection nodes, as well “mesh” relay communications between meters. The relay nodes and the data collection points may both utilize a 500 kHz communication band divided into 50 or 40 very narrowband sub-channels, which in this example are 10 kHz or 12.5 kHz wide. This increases the sensitivity of the transponders to the −130 dBM range and low data rates in the range of hundred of bits per second, which is well suited to Narrowband Internet of Things (NB-IOT) applications. The increased transponder sensitivity also increases the ability of the mesh system to communicate with hard-to-reach transponders and opens the system to a wider range of alternative communication hop paths.

### REFERENCE TO RELATED APPLICATION

This application claims priority to U.S. Provisional Patent Application Ser. No. 62/418,050 filed Nov. 4, 2016 entitled “Very Narrowband FDM (Frequency Division Multiplex) Mesh System,” which is incorporated by reference. This application is also related to the technology described in U.S. Pat. No. 7,808,938 granted Oct. 5, 2010, which is incorporated by reference.

### TECHNICAL FIELD

The present invention relates generally to multipoint or “mesh” communication systems and, more particularly, to a very narrowband mesh system using single-mode transponders.

### BACKGROUND OF THE INVENTION

Compared to other types of RF communication systems, automatic meter reading (“AMR”) systems are characterized by a relatively large number of meters that each transmit a relatively small amount of data infrequently at very low power. For example, a typical AMR system may include a number of data collection devices that each receive data from 10,000 to 100,000 meters reporting less than a kilobyte of data hourly at one mWatt. In the United States, the frequency band from 903 MHZ to 926 MHZ is available for this type of application but the governing regulations require very low broadcast power in the mWatt range. Other license exempt frequency bands around 2.4 GHZ and 5.8 GHZ are also available in the United States for some AMR applications, and a few different frequency bands are applicable in other countries. Within the license exempt frequency bands, the AMR communication protocol typically divides the operational frequency band into a number of channels and implements frequency or digital code hopping to reduce interference among the large number of transmitters using the frequency band. This enables the meters to transmit at one Watt rather than the one mWatt regulatory limit that applies to an unspread channel.

In general, AMR systems can be configured into coverage patterns based on the data handling capacities of the data collection devices and the transmission range and data transmission capacity of the meters (relay transponders). These components can be organized into simple point-to-multipoint configurations and more complex mesh networks. Ultimately, the cost and inefficiency of the AMR system can generally be reduced by increasing the data handling capacities of the data collection devices, the transmission range of the meters, and the data transmission capacities of the meters.

Conventional AMR systems use channel widths of 50 kHz with no frequency division multiplexing. A step beyond this is to employ a higher precision communication mode for communications between meters and data collection points, such as Frequency Division Multiplexing (FDM), and a second lower precision communication mode for “mesh” communications between meters. This requires dual-mode transponders, which increases cost and system complexity particularly when the system utilizes unlicensed communication bands with less precise frequency constraints. As a result, there is a continuing need for more efficient and effective communication protocols for AMR meter reading techniques.

### SUMMARY OF THE INVENTION

The present invention meets the needs described in a single-mode very narrowband mesh communication system in which the relay nodes (also referred to as transponders, which may be meters, IOT sensors, and the like) as well as the data collection points utilize the same type of very narrowband communication protocol. Fast Fourier Transform (FFT) techniques are used in both the relay nodes and the data collectors to enable very narrowband communication down to the relay node level. For example, the relay nodes and the data collection points may both utilize a 500 kHz communication band divided into 50 or 40 very narrowband sub-channels, which in these examples are 10 kHz or 12.5 kHz wide. A suitable type of data encoding protocol, such as Orthogonal Frequency Division Multiplexing (OFDM) or Single Carrier Frequency Division Multiplexing (SC FDM) is used to multiplex data among the very narrowband channels.

An embodiment of the present invention may be employed in a very narrowband automatic meter reading (“AMR”) system that utilizes single-mode meters (relay nodes or transponders) for “hop” communications between meters and data collection nodes, as well as “mesh” relay communications between meters. This increases the sensitivity of the transponders to the −130 dBM range for low data rates in the range of hundred of bits per second, which is well suited to AMR as well as internet-of-things (e.g., NB-IOT and LORAWAN) applications. The increased transponder sensitivity also increases the ability of the mesh system to communicate with hard-to-reach transponders, while opening the system to a wider range of alternative communication hop paths.

These features and the resulting advantages of the very narrowband communication system will become apparent to the skilled artisan upon examination of the following drawings and detailed description. It is intended that all such additional features and advantages be included within the scope of the present invention.

### BRIEF DESCRIPTION OF THE DRAWINGS

FIG. 1 is a conceptual diagram illustrating a very narrowband communication protocol for a mesh communication system.

FIG. 2A is a functional block diagram of a prior art very narrowband mesh system with dual-mode transponders.

FIG. 2B is a functional block diagram of an innovative very narrowband mesh system with single-mode transponders.

FIG. 3 is a conceptual illustration of a single-mode mesh system.

FIG. 4 is a conceptual illustration of a single-mode mesh system used to communicate with a hard-to-reach transponder inside a building or basement.

### DETAILED DESCRIPTION OF THE EXEMPLARY EMBODIMENTS

The present invention may be embodied in a very narrowband mesh communication system, such as an automatic meter reading (“AMR”) or narrowband internet-of-things (NB-IOT) system, that utilizes single-mode transponders for “hop” communications between relay and data collection nodes, as well “mesh” relay communications between relay nodes. In a mesh system, end point nodes typically operate as both data origination points and relay nodes. The term “relay node” therefore refers generally to data origination points as well as relay nodes. To provide an illustrative example, the relay nodes and the data collection points may both utilize a 500 kHz communication band divided into 50 or 40 very narrowband sub-channels, which in this example are 10 kHz or 12.5 kHz wide. A suitable type of data encoding protocol, such as Orthogonal Frequency Division Multiplexing (OFDM) or Single Carrier Frequency Division Multiplexing (SC FDM) is used to multiplex data among the very narrowband channels. This increases the sensitivity of the transponders to the −130 dBM range and low data rates in the range of hundred of bits per second, which is well suited to AMR and Narrowband Internet of Things (NB-IOT and LORAWAN) applications. The increased transponder sensitivity also increases the ability of the mesh system to communicate with hard-to-reach transponders, while opening the system to a wider range of alternative communication hop paths.

There are two main technologies to extend the range of systems that include a large number of distributed transponders served by a smaller number of data collectors, such as systems known as mesh, star, and point-to-multipoint communication systems. These systems may utilize a raised two-way data collector located on a pole or tower. Another option is Long Range Low Power (LORA) technology (see: www.lora-alliance.org), which utilizes Fast Fourier Transform (FFT), multiplex techniques, and turbo coding to achieve very narrowband communication channels (e.g., in the 10 kHz range) or ultra narrowband system (e.g., in the 1 kHz range) exhibiting high sensitivity in the −130 to −145 dBm range. Embodiments of the present invention combine these techniques throughout a mesh system to achieve the benefits of both and get the highest link budget possible, which might be referred to as a “massive link budget” approach. Where “single mode” mesh appears in the patent it describes the new technique that forms the core of this patent of mesh and FFT vNB/UNB together. This will be defined as single mode mesh for the purposes of this patent, so as not to be confused with the single mode or “peer to peer” aspect of conventional mesh systems.

In particular, a mesh configuration with a large number of relay transducers reduces the distance to the closest neighbor of a “hard-to-read” meter while increasing the number of neighbors within reach. Using very narrowband communication channels (e.g., in the 10 kHz range) down to the relay transponder level throughout the mesh system produces a double enhancement that improves the sensitivity, and thus the reach, as well as self-correcting ability of the mesh system. The resulting very narrowband (VNB) single-mode mesh system is particularly useful for hard-to-reach meter locations, such as AMR, NB-IOT system, and the emerging 5G communication infrastructure.

It may seem at first that the VNB single-mode mesh system produces too much link budget, but there is really no such thing as “too much” when it comes to link budget in a mesh system. In the unlicensed portion of the spectrum, it would be irresponsible to transmit an unnecessary amount of power to maintain a given link. To meet the spirit of the International Scientific and Medical (ISM) guidelines, communication in these bands, such as the 903 to 928 MHz band, should try to minimize interference to co-users as well as one's own system. To meet this objective, dynamic power control can be used where a mesh starts off at very low sub-milliWatt power level and builds up the mesh network to the point where it is reasonable and self-healing, such as 4 or 5 alternate paths to the data collector from a normally mounted meter or sensor. To track down “hard-to-read” meters, short bursts of “I am here” messages at the maximum transmit power may be employed from the hard-to-read meter once a basic mesh plan is established in order to find these meters. The mesh will rebuild every few minutes to track propagation changes and implement self healing, which is an often claimed advantage of the mesh topology.

The combined use of raised pole or tower mounted data collectors with very narrowband, single-mode transponders throughout a mesh system, results in massive controlled link budget (MCLB) that meets the spirit of part 15 for unlicensed bands in the United States by not creating excessive interference to other systems. Opportunities also exist for using the multiple narrowband channels to separate hops in the mesh system rather than a time division layer system that also creates unnecessary interference, capacity challenges and latency challenges.

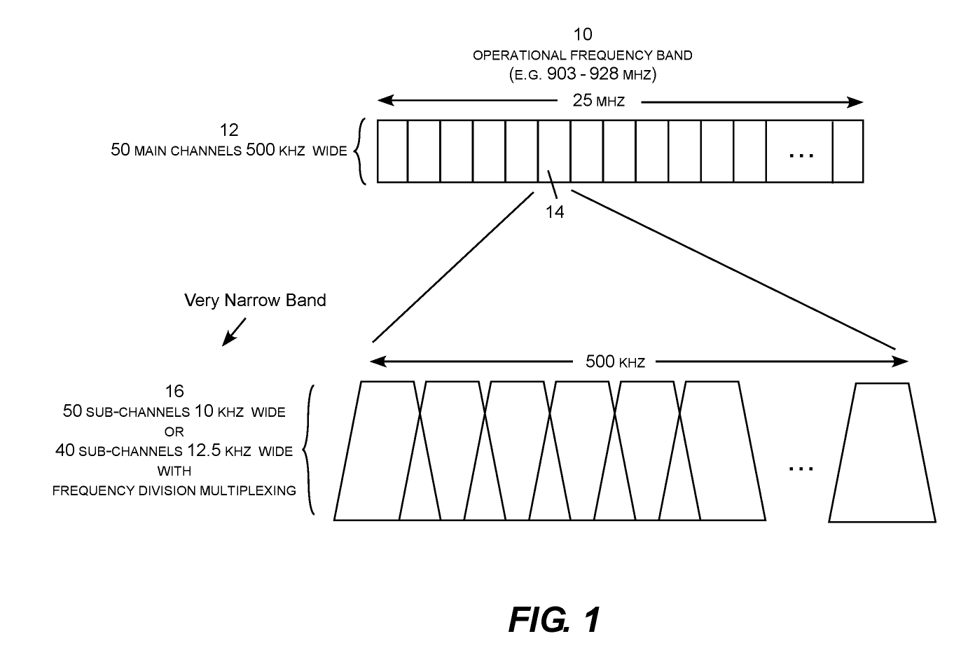

FIG. 1 is a conceptual diagram illustrating a very narrowband (VNB) communication protocol 10, which may be suitable for an Automatic Meter Reading (AMR) system, or other system that can benefit from the sensitivities and data rates achieved with this technology. This particular example includes an operational frequency 10 from 903 to 928 mHz. The 25 MHz operational frequency is divided into a number of main channels 12. In this particular example 50 main channels, each 500 kHz wide are used. The communication protocol applies frequency hop spread spectrum (FHSS) or digital hop spread spectrum (DHSS) among the main channels to limit interference. Referring to an illustrative main channel 14 shown in FIG. 1, the 500 kHz main channel is further divided into a number of very narrowband sub-channels 16, such as 50 sub-channels 10 kHz wide or 40 sub-channels 12.5 kHz wide (even higher numbers of narrower channels could be used for extremely hard to reach meters. However, a 10 kHz very narrowband combined with turbo coding and very stable modulation like BPSK to reduce the minimum signal-to-noise ratio (SNR) to about −4 dB will typically achieve about −136 dBm sensitivity, which will probably be sufficient in most cases). The communication protocol applies frequency division multiplexing among the sub-channels, which allows a relatively large number of meters to use each main channel (i.e., theoretically, up to 50 meters can be accommodated by the 50 sub-channels 10 kHz wide and 40 meters can be accommodated by the 40 sub-channels 12.5 kHz wide). Note the meters or sensors in IOT have very low duty cycle, so if duty cycle is 1 in a 1,000, 50,000 meters or 40,000 meters may be accommodated with these two schemes.

It should be appreciated that the 50 main channels 500 kHz wide occupy about 25 MHz of spectrum in the 903 to 928 MHz license exempt band. This is an example of frequency hopping spread spectrum, where the main channel hops is in synchronism between a data collector and the meters it serves on a set cyclic pattern. This reduces interference with other systems and users of the band and makes possible an uplift of allowed ERP (broadcast power) from 1 mWatt to 1 Watt for the band in compliance with FCC part 15 regulations. An alternative technique is to spread the 500 kHz main channel digitally by code division over the 25 MHz band. In either case, the hop pattern repeats cyclically. For a system with unidirectional meters for endspur applications, the data collection device first detects the frequency or code used by each meter and then follows each meter as it cycles through the hop pattern. For a system with bidirectional meters, the data collection device determines the frequency or code to be used by each meter and instructs and synchronizes each meter, which then follows the lead set by the data collection device.

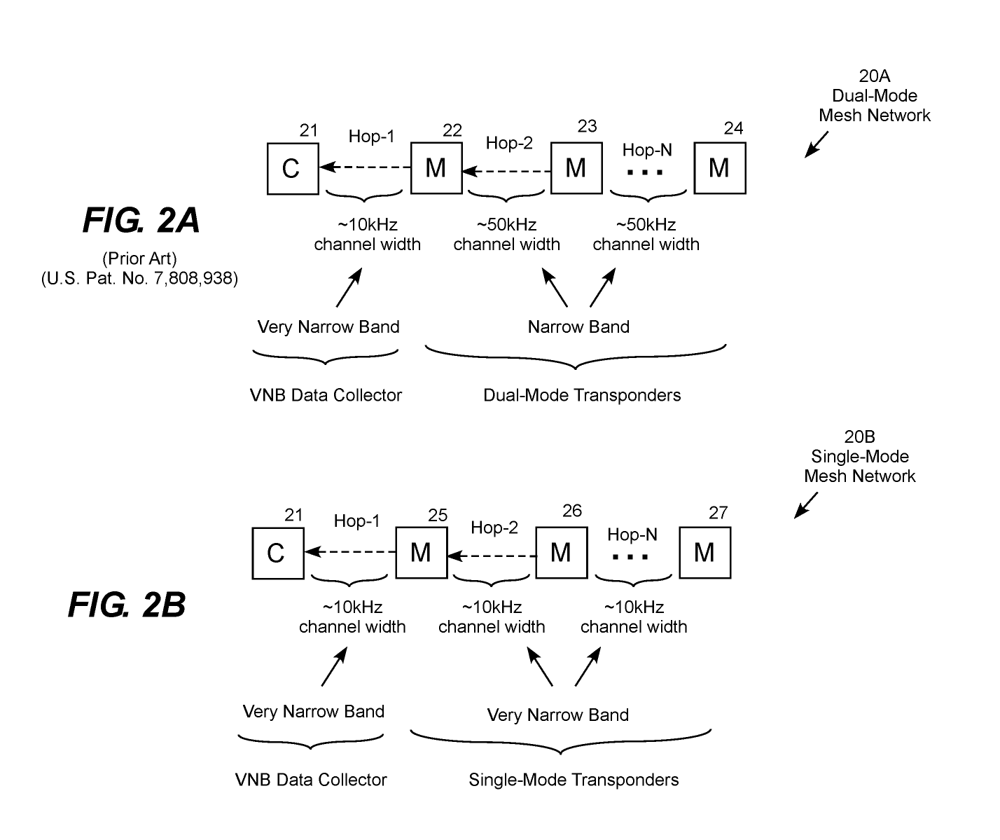

FIG. 2A is an illustration of a prior art dual-mode mesh communication system 20, an example of which is described in U.S. Pat. No. 7,808,938. A small portion of a mesh system is shown including a data collector 21 and several meters (relay transponders) 22a-22n. The first hop (hop-1) communications between the data collector 21 and the first meter 22a in a hop path that utilizes very narrowband channels (e.g., on the order of 10 kHz per channel, as shown in FIG. 1), while meter-to-meter relay (mesh) communications use a less precise narrowband channels (e.g., on the order of 50 kHz per channel). This paradigm requires dual-mode transponders (relay meters) operative for communicating using the narrowband channels (˜50 kHz) as well as the very narrow arrow band channels (˜10 kHz).

FIG. 2B is an illustration of an innovative single-mode mesh communication system 20 in accordance with the present invention. Again, a small portion of a mesh system is shown including a data collector 21 and several meters (relay transponders) 25a-25n. In this single-mode system, the first hop (hop-1) communications between the data collector 21 and the first meter 25a in a hop path utilizes very narrowband channels (e.g., on the order of 10 kHz per channel, as shown in FIG. 1), while meter-to-meter relay (mesh) communications also use the same very narrow communication channels. This paradigm thus eliminates the need for transponders capable of communicating over the less precise narrowband channels (e.g., on the order of 50 kHz per channel). This paradigm only requires single-mode relay transponders (meters) operative for communicating on the very narrow arrow band channels (˜10 kHz). The single-mode narrowband mesh system exhibits increased transponder sensitivity to the −130 dBm range, increases the ability of the mesh system to communicate with hard-to-reach transponders (meters), and opens the system to a wider range of alternative communication hop paths.

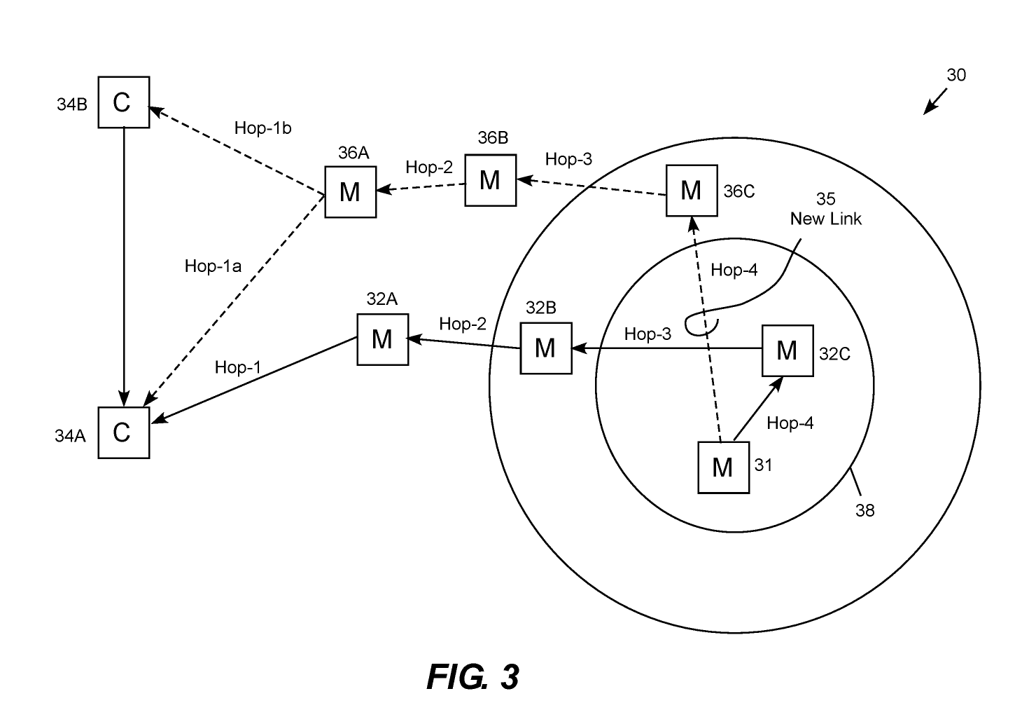

FIG. 3 is a functional block diagram of a very narrowband mesh system 30 that utilizes single-mode meters (transponders) 31, 32A-12C and 36A-36D to a relay data to collection devices 34A-34B. Embodiments of the present invention also include FDM or SC FDMA or DSP-created operation at each meter, which enhances the range of each relay link. The single-mode transponders use the same communication mode for “hop” communications between meters and data collection nodes, as well “mesh” relay communications between meters. This opens the mesh system 30 to a wider range of alternative communication hop paths. In FIG. 1, a hard-to-read meter 11 exhibits a conventional range without FDM DSP denoted by the inner circle 38, which limits the meter to communications with only one other meter 32C. As a result, reception is rather prone to fades and is unreliable. When the range is enhanced, this link is much more reliable because two additional neighboring meters 32B and 36C are in range enabling a greater number of choices to relay routes back to multiple data collectors 14A and 14B. This increases the mesh link options, resulting in greater system reliability and lower cost.

For example, a “first hop” path from data collection device 34A to meter (transponder) 31 includes a first (hop-1) to meter 32A, a second (hop-2) to meter 32B, a third (hop-3) to meter 32C, and a fourth (hop-4) to meter 11. In a conventional dual-mode mesh system, the meters 31, 32B and 32C act as “mesh” or relay transponders using a first communication mode for meter-to-meter communications, while the meter 32C acts as a “hop” transponder using a second communication mode for meter-to-data collection node communications. The single-mode operation of the meters opens the mesh system 30 to a wider range of alternative communication hop paths. For example, the alternative path 35 is available for the single-mode mesh system, including alternate first hops (hop-1a and hop1b) from the first data collection point 34A or the second data collection point 34B to the meter 36A, a second (hop-2) to meter 36B, a third (hop-3) to meter 36C, and a fourth hop (hop-4) to meter 11.

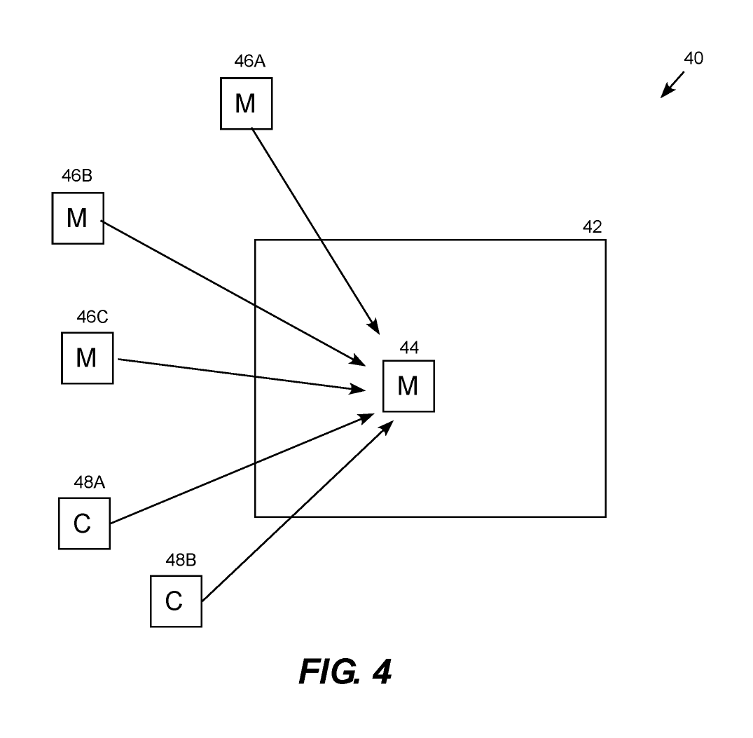

FIG. 4 is a conceptual illustration of the mesh system 40 used to communicate with a hard-to-reach meter (transponder) 44, such as a meter located deep inside a building 44. Similar hard-to-reach transponder situations occur in hilly areas where the terrain limits transponder reach, in industrial sites, in IOT applications with very low power transponders, with transponders carried on vehicles, and so forth. The use of single-mode very narrowband transponders throughout the mesh system allows the hard-to-reach meter 42 to communicate with any relay node or data collection point with which it can establish a radio link using the same very narrowband communication channels. In this example, for instance, the hard-to-reach meter (transponder) 42 can communicate with any of the meters (transponders) 46A-C or the data collection points 48A-B using the same very narrowband communication mode. This significantly increases the sensitivity and simplifies the transponders (i.e., single-mode versus dual-mode), while increasing the communication path options to the transponder 42. The single-mode, very narrowband mesh system can therefore be used to reach a “hard-to-read” meter in a building or other difficult communication situation, which increases the meshing depth and healing ability of the mesh network.

The single-mode, very narrowband communication system is particularly well adapted for use in any application characterized by a relatively large number of transponders that each transmits a small amount of data infrequently at low power. The illustrative very narrowband point-to-multipoint communication systems described in this disclosure are specifically designed for an automatic meter reading (“AMR”) system, but may be used in other applications having similar characteristics, such as NB-IOT, LORA, LPWA and similar applications. The principle advantages of the single-mode, very narrowband mesh communication system are greater transmission range, greater packet bandwidth, and the ability to accommodate a much larger number of transponders per data collection device in comparison to conventional narrowband communication systems. These advantages result from the communication protocol implemented by the system, in which the narrowband channels typically used in a point to multipoint communication system are further divided into very narrowband sub-channels, which are multiplexed to accommodate multiple transponders per narrowband channel. For an AMR system with relatively low data rates, the very narrowband communication protocol typically implements as many as 40 or 50 sub-channels per main channel.

In an illustrative AMR system, for example, the communication protocol divides a 25 MHz operational frequency band from 903 MHz to 928 MHz into 50 main channels nominally 500 kHz wide, which typically are somewhat wider and overlap each other to some extent. The system applies frequency or digital code hopping to the main channels to limit interference, and further divides each 500 kHz main channel into very narrow sub-channels, such as 50 sub-channels 10 kHz wide or 40 sub-channels 12.5 kHz wide, and applies frequency division multiplexing among the sub-channels. This allows each sub-channel to exhibit a very narrowband characteristic (i.e., 10 or 12.5 kHz) that allows the gain to be significantly increased within the very narrowband, which increases the transmission range of the meters. In addition, frequency division multiplexing among the sub-channels greatly increases the number of meters that can communicate on each main channel (e.g., theoretically up to 40 or 50 meters per main channel). The data collection device demodulates and decodes the multiplexed meter signals at an intermediate frequency that allows the digital signal processing to be implemented with electronic circuitry.

U.S. Pat. No. 7,808,938 granted Oct. 5, 2010, which is incorporated by reference, describes dual-mode meters (transponders) that communicate via a tower based link using very narrowband channels that are modulated on each of 50 hop channels in a spread spectrum system. The system uses multiple very narrowband subchannels modulated onto a spread spectrum channel in a Frequency Division Multiplex (FDM) format that achieves high sensitivity at low data rates, or good sensitivity at higher data rates, by combining channels through multiplexing the very narrowband channels. This technique is well suited for a system that includes a large number of meters located close to the data collection device, which carries a substantial amount of relayed data.

The meters (“hop” or “mesh” relay nodes) in this type of system may have their frequency measured by the pole-mounted or tower-top data collection devices (data collection nodes). The transmitters in the meters must be tuned onto the exact frequency used by the data collection devices in order to achieve two-way communication on a very narrowband. The comb nature of these narrowband channels means relatively precise frequency is not required. So, an extremely accurate frequency source, such as an expensive quartz crystal signal generator, is not necessary.

The mesh meters operating as relay transponders in this type of system typically communicate with the other mesh meters by less precise conventional receivers with a bandwidth of about 50 kHz or so, which doesn't present a crystal signal generator error challenge. Any meter could become a first hop meter, although GPS or LATLONG meters are generally not used to define a first hop meter. Thus, each meter operates in two modes, which may be referred to as “hop mode” or “mesh mode.” Hop mode is a more precise mode used to communicate between meters (relay nodes) and data collectors (data collection nodes), whereas mesh mode is a less precise mode used to communicate between meters (relay nodes). In hop mode, the meters form a kind of focus for mini-mesh systems connected by a high sensitivity very narrowband (VNB) backhaul in the first hop.

Embodiments of the present invention obviates the need for dual-mode meters by utilizing single-mode meters that communicate with other meters (relay nodes) and data collection devices (data collection nodes) using the same lower precision communication mode. This is because lower costs and the incorporation of chip transponders in the meter make it in essence the same as a data collector in terms of hardware and air interface, though functionally still different as the data collector needs to collect the data and provide a backhaul to concentrate it to a POP. Instead of relying on dual-mode meters, each single-mode meter utilizes very narrowband channel selection to minimize interference caused by data collisions. In the case of asynchronous operation, a large number of single-mode meters utilize very narrowband sub-channel selection within a larger communication band to minimize data collision interference with other meters. This type of system is easy to operate in an unlicensed band, similar to conventional mesh systems utilizing dual-mode meters, but one step better by allowing the use of single-mode meters for “hop” communications between meters (relay nodes) and data collectors (data collection nodes), as well as “mesh” between meters (relay nodes). Conducting all such communications with the same communication mode allows the transponders in data collection devices to operate both as data collection nodes and as mesh relay nodes. As a result, the mesh system becomes open a wider range of alternative communication hop paths, including paths in which data collection devices serve as data collection nodes, as well as paths in which data collection devices serve as “mesh” relay nodes.

The mesh system described in U.S. Pat. No. 7,808,938 utilizing dual-mode meters was designed before the days of large scale uptake of frequency division multiplexed (FDM) encoded data in telecommunication systems, as in the Long-Term Evolution (LTE) 3rd Generation Partnership Project (3GPP) standard, for instance. This standard uses orthogonal frequency division multiplex (OFDM) data encoding in the downlink and Single Carrier Frequency Division Multiplex (SC FDMA) in the uplink. This type of infrastructure exhibits a low linearity transmitter requirement. Note that OFDM needs high linearity, SC FDMA has a lower linearity requirement, which facilitates the advance of the present invention in which “smart meter” or Advanced Meter Infrastructure (AMI) system can be implemented utilizing single-mode meters (relay transponder). This novel approach is well suited for AMI systems that do not require ultra-high data rates, such as wireless IP systems, because the SC FDMA protocol requires a lower peak power ratio (PAPR) and hence less demand on the linearity of the power amplifier in the meter transmitter. This is similar to the fourth generation (4G) smartphone protocol using SC FDMA in the uplink for the same reasons. In fact, the data handling capacity of 4G uplinks is quite substantial compared with the needs of a mesh meter system. As a result, the single-mode mesh system of the present invention is readily compatible with 4G and simpler types of SC FDMA or even less demanding data encoding schemes, such as frequency shift-key (FSK), on-off keying (OOK), or quaternary phase shift keyed (QPSK) in both link directions.

Since all of the meters (relay nodes) in the single-mode mesh system may contain the same type of single-mode radio rather than dual-mode radios, the notion of “mesh nodes” versus “hop nodes” can be dispensed with, thus simplifying the system. The single-mode mesh system can therefore operate as point-to-multipoint or mesh applications with equal ease, using the same meshing protocol utilized in existing systems in mesh and point-to-multipoint systems. The single-mode radios can even communicate with existing mesh system radios if the protocol is known, which can provide an overlay of the smarter “generation 2” meters to strengthen the communication backbone.

Single-mode meters can also provide a solution in “hard-to-read meter” locations. These hard-to-read locations are a major problem for both mesh and LORA (Long Range Wide Area) systems.

Recent radio technologies lower transmitter cost and linearity requirements, facilitating the more recent LORA standards and the appearance of NB-IOT and cat M1 in the case of cellular 4G networks as an addition to existing 4G categories. The present invention is not limited to cellular networks or from LORAWAN based networks, but provides a mix of mesh as defined on WI-SUN or 802.15.4g based networks as one possible base and an extension of these technologies to implement enhanced reach and radio link budget to existing mesh networks.

In fact, if the technologies described in U.S. Pat. No. 7,808,938 are adhered to, the advantages of the present invention are not limited to or reliant on LORAWAN or WI-SUN standards, but pertain more generally to the mesh techniques described in U.S. Pat. No. 7,808,938, which significantly predates these other standards. The present invention is therefore an original, generally applicable solution that is not dependent on any existing communication protocol or standard.

It should be appreciated that U.S. Pat. No. 7,808,938 describes very narrowband FDM used on the link between the tower-mounted data collection point (data collection node) to the first-hop meter (relay node) only, and the rest of the hops (between relay nodes) in the mesh system being conventional direct-conversion type radio links achieving perhaps −110 dBm sensitivity, termed mesh meters (relay nodes). The LTE standard OFDM defines links that are capable of −136 dBm and are 15 kHz wide. In reality, only blocks of channels are used in 4th Generation LTE. A single 15 kHz channel at a resource element level cannot be used for data transmission, only for pilot tones. The narrowband channels would be desirable for IOT narrowband and attempts at this are being made with the emergent narrowband NB-IOT and 5G standards. Such technology is hardly a new, however, and only one possible scheme. Another significant advantage of OFDM with overlapped narrow channels are described in U.S. Pat. No. 7,808,938. This solution finds little application in the 4G world as the high data rates demand high degrees of multiplexing. In fact, LTE cannot multiplex less than 12 channels in a resource block, so the theoretical sensitivity of −136 dBm cannot be achieved. Embodiments of the present invention may therefore be more applicable to 5G system providing a capability for low data rates encountered in Internet of Things (IOT) or in the emerging Narrowband Internet of Things (NB-IOT) standards expected to precede and accommodate the 5G standards.

The reason for the dual-mode architecture described in U.S. Pat. No. 7,808,938 was the need at the time for economic meter transceivers. This architecture of itself did not need FDM capable radios in the meters, which was considered too expensive. The advanced FFT DSP techniques were only needed in the data collector, which could then cover very large areas from the tower. This is a bit like the Sensus Flexnet system except it works in an unlicensed band. Now with the proliferation of Software Defined Radio (SDR) and standards specified FFT radios of various kinds appearing in products, it is considered relatively economic to implement embodiments of the present invention utilizing FFT DSP receivers in each meter (rely transponder) in the mesh system. Conventional LORAWAN transponders implement all these techniques, including FFT processing in a very small chip that can enable a match box sized transponder to communicate over 10 Km in ultra-narrowband mode (i.e., a few hundred bits/sec). The spread of advanced DSP techniques to the meters (relay nodes) from the data collector (data collection nodes) represents an important progression from the technology developed from 10 years ago, when tiny transponders performing advanced DSP techniques were not possible.

The ubiquitous deployment of relay nodes implementing advanced DSP techniques brings about a number of operating advantages for AMI systems. Referring to diagram 1 above, an especial weakness of mesh is that the end spur meters are often isolated from other mesh meters by being in a propagation unfriendly setting such as indoors or in a basement. The only way to reach such meters or endpoints is through a relatively narrow path. Hard-to-reach meters present another drawback, such as a meter located in a valley in a hilly area. In this situation, the meter in the valley can only propagate through one line down the valley, which inhibits a mesh configuration that includes a number of links between this meter and a number of other meters. Here, the hard-to-reach meter results in a chain of rather short links exhibiting inherently low reliability (i.e., reliability controlled by the weakest link in the chain). It would be much better for each meter to have multiple links available to multiple relay transponders in a mesh configuration exhibiting much higher link margin and system reliability.

For such “hard-to-read” meters, conventional mesh techniques can help somewhat, but very often doesn't provide a complete solution because the unfavorable environmental RF characteristics tend to attenuate the signal across the board, so that all the neighboring meters have difficulty reaching the hard-to-read meter. In other circumstances, “hard-to-read” meters problems can arise reaching far inside buildings. These problems can only be solved by using Power Line Carrier (PLC) modems through the power lines themselves or WIFI coverage if a suitable router can be installed or piggy backed off an existing install of WIFI routers. For instance, the ITRON RIVA system based on the Openway mesh system offered by Itron, Inc. offer all three modems in one meter to provide a massively diverse solution, but only at great expense.

Embodiments of the present invention include FDM or SC FDMA or DSP-created operation at each meter, which enhances the range of each relay link. In FIG. 3, a hard-to-read meter 31 exhibits a conventional range without FDM DSP denoted by the inner circle 38, which limits the meter to communications with only one other meter 32C. Radio reception is rather prone to fades and is unreliable. When the range is enhanced, each link is much more reliable because two additional neighboring meters 32B and 36C are in range enabling a greater number of choices to relay routes back to multiple data collectors 14A and 14B.

The data collectors are typically tower mounted (or at least pole mounted). One problem with tower mount is that while it undoubtedly improves RF propagation, the level of interference in an Industrial, Scientific and Medical (ISM) band also increases, which may limit its use to rural locations. While this is considered manageable with a DSP FFT solution, the interference potential tends to promote licensed bands over ISM. For instance, Sensus uses similar DSP enhancement of sensitivity to a −133 dBm on a close-by 900 MHz licensed band to the AMR 900 MHz ISM band. In a single-mode mesh system, the range enhancement comes through relaying of links and so the data collector can be pole mounted or in a meter location, so ISM interference is less of a problem.

The single-mode mesh system also eliminates or reduces the need for repeaters and reduces or eliminates the need for solutions that use multiple technologies within a single meter. The single-mode mesh radio penetrates further into large buildings reliably, which reduces or obviates the need for diversity with alternate technologies while achieving 99.9% or so coverage with minimal deployment planning. A realized −136 dBm may more practically be −130 dBm and represent a 20 dB uplift over a conventional sensitivity of −110 dBm. This represents an approximate quadrupling of range making “hard-to-read” and building penetration much more practical with less deployment planning and effort.

The observation that modems have already appeared that can achieve a 10 miles range with one Watt transmission power, code division or chirp techniques clearly shows that DSP techniques are now economic at system endpoints that were not considered to be economically available ten years ago. In fact, certain chirp techniques employed today are similar to those described in U.S. Pat. No. 7,808,938 ten years ago. The tolerance of crystal error and the overlapped sub-channels as described in this patent for interpreting packets at the interface between two overlapped channels may be referred to as “chirp” today. The requirement to hop 50 channels which are in themselves 10 to maybe 100 subchannels may be either performed by hopping the whole block across 50 channels or filling the whole band with 1000's of subchannels and hopping a few or even one sub-channel at a time. No real minimum hop is specified in part 15, but presumably will be more than one communication channel). The channels could also be divided by a Pseudo-Noise (PN) code that is modulated on top of a group of subchannels or even a second level spreading code that like a turbo code enhance the sensitivity in an alternate approach to very narrowband

There may be a tendency to associate LORA technology with point-to-multipoint or star technologies and mesh with peer-to-peer technology. The two main camps for LPWAN's are the WI-SUN alliance for mesh and LORAWAN Alliance for star technology. The star technology would be impractically expensive for certain applications intended if long range is not achieved to compete with mesh. But enhanced mesh through the use of DSP and narrowband techniques thus far described goes a level further toward range enhancement.

There is no reason to not combine the two technologies to achieve the benefits of both and get the highest link budget possible. This might be called a massive link budget that achieves the enhancements of both. Mesh will reduce the distance to the closest neighbor of a “hard-to-read” meter and increase the number of neighbors within reach, so this double enhancement improves reach and improves mesh self-correcting ability at the same time.

It may seem at first that there is too much link budget but there is really no such thing as “too much” when it comes to link budget. However, in the unlicensed spectrum it is responsible to not transmit an unnecessary amount of power to maintain a given link. To meet the spirit of part 15 one should try to minimize interference to co-users as well as one's own system.

Dynamic power control can be used where a mesh starts off at very low sub-milliwatt power level and builds up the mesh network to the point where it is reasonable and self-healing (e.g., 4 or 5 alternate paths to the data collector). To track down “hard-to-read” meters, short bursts of “I am here” at the maximum transmit power may be employed once a basic mesh plan is established in order to find these meters. The mesh will rebuild every few minutes to track propagation changes and implement self-healing, which is an often claimed advantage of mesh technology.

The present invention thus includes the use of single-mode meters (as described in this patent) for high performance mesh systems, as well as dual-mode where the new meters use an enhanced DSP/FFT protocol and a simple protocol to interface with deployed mesh to enhance the number of pathing options available in the mesh. These techniques ease the “hard-to-read” meter problem by enhancing the penetration of mesh by substantially increasing the meter receiver sensitivity on the order of 20 dB over conventional receiver and transmit technology.

The present invention enables the use of a novel and simplified air interface protocol based on SC FDMA (form of frequency division multiplexing) with simple PSK/OOK and low data rate modulation schemes and variants thereof optimized for the meter reading application across a range of data rates, increased battery life and lower cost transmitters. The system described includes a form of frequency division multiplex with a degree of overlaps of the subchannels, such that there is no significant distortion of the received signals due to crystal errors. This is not strictly a chirp scheme but makes +−10 ppm or more crystals practical. The single-mode system produces additional link path options where a tower mounted data collector is deployed for first hop and use of certain meters to form mini-mesh systems.

In these systems, ten or in some cases more narrow subchannels may be utilized in parallel to enhance the data rate, especially on first and second layer meters to enhance traffic and reduce latency, with those relay nodes closer to the data collector carrying greater data. Two types of frequency hopping may be used, either 50 main channels containing 10 to 100 subchannels or hop across 1000's of subchannels in an FCC approvable scheme. A similar result can be accomplished digitally by PN codes in spread spectrum either spreading all the 1000's of channels into a PN code or a two-level code, one to perform 50-way spread and the other to massively turbo code the data to achieve sensitivity uplift.

QPSK and other modulation schemes may be utilized up to 64QAM to enhance data rate automatically. This is similar to LTE standards, but optimized for the mesh meter reading application. This will enhance capacity for mesh meters that need to carry additional meter traffic or traffic from other systems and outage traffic associated with “last gasp”. Rapid power control, such as used in CDMA, may be used to offset excess link budget or when it is not necessary to use high M-ary schemes. A mesh may be built intelligently using geographic information if available and Relative Received Signal Strength (RSSI measurements may be used to find the best mesh. Such measurements may be used to minimize mesh associated COST. COST, as used here, is a term used by mesh engineers to define the efficiency of the routing from endpoint to the data collector.

Single-mode mesh solution can be used to enhance link budget to break down the mesh into mini-mesh systems. Where data rate permits, the interference rejection characteristics inherent to narrowband can be used to elevated data collectors on radio towers and poles to leverage capacity enhancement. The need for multiple technology solutions for end spur meters can be eliminated by creating so much link budget through a combination of mesh and DSP very narrowband protocols, that every conceivable meter location e.g., inside large buildings, in valleys, etc.) can be covered through massively excess link budget between the data collector and the meter.

Turbo codes can be used in the FDM system where applicable. For instance, the narrow channels could be 10 to 15 KHz wide. While this in itself may not achieve a −136 dBm sensitivity, these techniques may be used to achieve this on a 15 kHz wide channel on LTE systems. If turbo codes are not used, highly UNB channels could be used by dividing the band into 1000's of channels of around one Kilohertz bandwidth. Therefore there are actually two techniques to achieve high sensitivity VNB.

Looking at VNB (very narrowband) and UNB (ultra narrowband), UNB divides the channels even more than 10 kHz to perhaps 1 kHz to achieve −130 to −140 dBm sensitivity through the channel itself. This may be advantageous to endpoints with power constraints (i.e., battery operation). VNB achieves a similar sensitivity by coding and turbo coding. However this can be heavy on system resources increasing power consumption.

Bandwidth reduction from 50 kHz to 10 kHz does not of itself provide a large sensitivity improvement but in relation to turbo coding, the gain from a typical −110 dBm of typical LTE to a full turbo coding is in line with low data rates for AMI/IOT and achieves a full 20 dB link budget gain to −130 dBm.

In view of the foregoing, it will be appreciated that the present invention provides significant improvements in multipoint communication systems generally and AMR systems in particular. The foregoing relates only to the exemplary embodiments of the present invention, and that numerous changes may be made therein without departing from the spirit and scope of the invention as defined by the following claims.

1. A single-mode mesh communication system, comprising:
a plurality of relay transponders;
a plurality of data collection devices;
wherein the relay transponders utilize the same very narrowband mode of communication for hop communications between the relay transponders and the data collection devices, as well mesh relay communications between the relay transponders.

2. The single-mode mesh communication system of claim 1, wherein the data collection devices are configured to operate alternatively as data collection nodes and as mesh relay nodes.

4. The single-mode mesh communication system of claim 1, wherein multiple transponders and multiple data collection devices are configured to alternatively communicate with a hard-to-reach transponder to provide multiple communication paths from the hard-to-reach transponder to an associated data collection device.

6. The single-mode mesh communication system of claim 1, wherein each transponder and each data collection device implements Frequency Division Multiplex or Single Carrier Frequency Division Multiplex protocol.

7. The single-mode mesh communication system of claim 6, wherein multiple transponders and multiple data collection devices are configured to alternatively communicate with a hard-to-reach transponder to provide multiple communication paths from the hard-to-reach transponder to an associated data collection device.

7. The single-mode mesh communication system of claim 1, wherein the relay transponders and data collection points comprise elements of an automatic meter reading system.

8. The single-mode mesh communication system of claim 1, wherein the relay transponders and data collection points comprise elements of a narrowband internet-of-things (NB-IOT) system.

9. The single-mode mesh communication system of claim 1, wherein the relay transponders and data collection points comprise elements of a Long Range Wide-Area Network (LORAWAN) system.

10. The single-mode mesh communication system of claim 1, wherein the relay transponders and data collection points comprise elements of a 5G communication system.

11. The single-mode mesh communication system of claim 1, wherein the very narrowband communication mode comprises approximately 40 very narrowband communication channels with a frequency bandwidth of about 12.5 kHz.

12. The single-mode mesh communication system of claim 1, wherein the very narrowband communication mode comprises approximately 50 very narrowband communication channels with a frequency bandwidth of about 10 kHz.

13. The single-mode mesh communication system of claim 1, wherein the very narrowband communication mode further comprises Fourier Transform (FFT) techniques in both the relay transponders and the data collection devices to enable very narrowband communication down to the relay transponders level.

14. The single-mode mesh communication system of claim 1, wherein the very narrowband communication mode further comprises transponder sensitivity in the range of −130 dBM to −145 dBM for low data rates in the range of hundred of bits per second.

15. The single-mode mesh communication system of claim 1, further comprising physically elevated data collection points combined with very narrowband communication channels in the 10 kHz to 12.5 kHz range.

16. A single-mode mesh communication system, comprising:
a plurality of relay transponders;
a plurality of data collection devices;
wherein the relay transponders utilize the same very narrowband mode of communication for hop communications between the relay transponders and the data collection devices, as well mesh relay communications between the relay transponders, comprising:
Frequency Division Multiplex or Single Carrier Frequency Division Multiplex protocol, and
approximately 40 very narrowband communication channels with a frequency bandwidth of about 12.5 kHz or approximately 50 very narrowband communication channels with a frequency bandwidth of about 10 kHz.

17. The single-mode mesh communication system of claim 16, wherein the relay transponders and data collection points comprise elements of one or more of the following:
an automatic meter reading system;
a narrowband internet-of-things (NB-IOT) system;
a Long Range Wide-Area Network (LORAWAN) system; and
a 5G communication system.

18. The single-mode mesh communication system of claim 17, further comprising physically elevated data collection points combined with very narrowband communication channels in the 10 kHz to 12.5 kHz range.

19. A single-mode mesh communication system, comprising:
a plurality of relay transponders;
a plurality of physically elevated data collection devices;
wherein the relay transponders utilize the same very narrowband mode of communication for hop communications between the relay transponders and the data collection devices, as well mesh relay communications between the relay transponders, comprising:
Frequency Division Multiplex or Single Carrier Frequency Division Multiplex protocol, and
approximately 40 very narrowband communication channels with a frequency bandwidth of about 12.5 kHz or approximately 50 very narrowband communication channels with a frequency bandwidth of about 10 kHz; and
wherein the very narrowband communication mode further comprises transponder sensitivity in the range of −130 dBM to −145 dBM for low data rates in the range of hundred of bits per second.

20. The single-mode mesh communication system of claim 19, wherein the relay transponders and data collection points comprise elements of one or more of the following:
an automatic meter reading system;
a narrowband internet-of-things (NB-IOT) system;
a Long Range Wide-Area Network (LORAWAN) system; and
a 5G communication system.
